(19) United States
(12) Patent Application Publication
(10) Pub. No.: US 2009/0131048 A1
(43) Pub. Date: May 21, 2009

(54) MOBILE COMMUNICATION SYSTEM, MOBILE TERMINAL DEVICE, METHOD OF DETECTING FREQUENCY USED IN THEM, AND PROGRAM FOR DOING THE SAME

(76) Inventor: Takahiro Kuriyama, Tokyo (JP)

Correspondence Address: NEC CORPORATION OF AMERICA, 6535 N. STATE HWY 161, IRVING, TX, 75039, US

(21) Appl. No.: 12/293,005

(22) PCT Filed: Mar. 5, 2007
(86) PCT No.: PCT/JP2007/054182

§ 371 Date: Sep. 15, 2008

(30) Foreign Application Priority Data
Mar. 15, 2006 (JP) 2006-070115

(51) Int. Cl. H04W 4/00

(52) U.S. Cl. 455/434

(57) ABSTRACT

A mobile communication system is comprised of a mobile phone device, a GSM network, and a W-CDMA network. A controller mounted in the mobile phone device updates GSM actually-used frequency data or W-CDMA actually-used frequency data both stored in a memory, in accordance with a DL frequency of a GSM cell or a W-CDMA cell detected by means of a GSM cell-searcher or a W-CDMA cell-searcher. The controller determines non-used frequencies not used in each of frequency bands, based on the actually-used frequency data, and causes the GSM cell-searcher or the W-CDMA cell-searcher to carry out cell-searching only with frequencies which may be used, except non-used frequencies.

### BACKGROUND OF THE INVENTION

1. Field of the Invention

The invention relates to a mobile communication system, a mobile terminal device to be used in the mobile communication system, a method of detecting a frequency to be used in the mobile communication system and the mobile terminal device, and a program for carrying out the method, and more particularly to a method of detecting a frequency to be used in a mobile terminal device such as a mobile phone device making communication through a plurality of radio-signal communication systems and at a plurality of frequency bands.

2. Description of the Related Art

A radio-signal communication system for a mobile phone system can be grouped into a TDMA (Time Division Multiple Access) system and a CDMA (Code Division Multiple Access) system. Furthermore, the TDMA system includes a plurality of radio-signal communication systems such as GSM (Global System for Mobile Communications) and PDC (Personal Digital Cellular), and the CDMA system includes a plurality of radio-signal communication systems such as W-CDMA (Wideband-CDMA), cdma 2000, and TD-SCDMA (Time Division-System Code Division Multiple Access) (for instance, see the non-patent reference 1).

As mentioned above, there are various radio-signal communication systems as a radio-signal communication system to be used for a mobile phone system. A particular frequency is assigned to each of radio-signal communication systems such that a common frequency is not used in different radio-signal communication systems from one another.

However, since frequencies are finite, a common frequency band is used in different radio-signal communication systems in a mobile phone system. For instance, frequencies between 800 MHz and 2 GHz are used in GSM and PDC both called the second generation, and in W-CDMA and cdma 2000 both called the third generation. Used frequencies are different from one another in each of countries.

On the other hand, with development of global roaming by internationalization, there is generally used a mobile phone device which is able to conform to a plurality of radio-signal communication systems or to a plurality of frequency bands. For instance, there is already actually used a mobile phone device which is able to conform to triple bands (GSM 900, DCS1800, PCS1900) or quad bands (GSM 850, GSM 900, DCS1800, PCS1900), or dual modes (GSM, W-CDMA) or triple modes (GSM, W-CDMA, cdma 2000).

While various frequencies are used in each of countries in the world, there is a demand that a single mobile phone device is able to conform to a greater number of radio-signal communication systems or frequency bands. In order to make a single mobile phone device conform to a plurality of radio-signal communication systems or a plurality of frequency bands, it is necessary for a mobile phone device to be able to detect a radio-signal communication system in which a particular frequency is used. Such detection of a radio-signal communication system would take a longer time or consume a current much more as a mobile phone is necessary to conform to a greater number of radio-signal communication systems or frequency bands.

Accordingly, it is necessary to effectively identify a radio-signal communication system and detect a frequency.

Non-patent reference 1: “W-CDMA mobile communication system chapter 1 abstract” supervised by Keiji Tachikawa (published by Maruzen Kabushiki Kaisha on Jun. 25, 2001, pp. 1-21)

A mobile phone device which is typical of a mobile station detects a stand-by cell by carrying out measuring a strength of an electric field of a received signal, cell-searching for synchronizing with a cell conforming to a certain radio-signal communication system, and receiving annunciation data transmitted from a base station.

While being in a stand-by mode, a mobile station searches cells existing therearound in accordance with frequency data includes in adjacent-cell data included in annunciation data transmitted from a base station, to thereby choose a qualified cell among a plurality of cells. Furthermore, a mobile station memorizes frequency having been used and frequencies of adjacent cells, and uses a frequency having been used immediately before or in the past when a power thereof is on or when it is in an area where radio-signals cannot reach thereto, to thereby be able to detect a stand-by cell for a short period of time.

If a mobile station conforms to a plurality of radio-signal communication systems or a plurality of frequency bands, the mobile station memorizes frequencies used in each of radio-signal communication systems, and makes use of data about a radio-signal communication system or a frequency band having been used immediately before or in the past when a power thereof is on or when it is in an area where radio-signals cannot reach thereto, to thereby be able to detect a stand-by cell for a short period of time.

However, the above-mentioned process is accompanied with a problem that if a mobile station is located in a strange area, the mobile station has to carry out cell-searching through all of radio-signal communication systems to which the mobile station conforms and at all frequencies in all of frequency bands, resulting in that cell-searching takes long time and consumes much current.

Furthermore, when a mobile station often moves between areas in which different radio-signal communication systems from each other and different frequencies from each other are used, it is sometimes impossible to detect a stand-by cell in a short period of time.

Furthermore, when a mobile phone device is located out of a service area in which the mobile phone device cannot detect a network, or when a network with which a mobile phone device is able to make communication is detected in an automatic network selection process in which a network having a higher priority that of a presently selected network is to be selected, or in a manual network selection process in which a user of a mobile phone device selects a network to be used, it is necessary for a mobile phone device to carry out cell-searching through all of radio-signal communication systems the mobile phone device conforms to or at all of frequencies the mobile phone device conforms to, resulting in a problem that it would take much time for carrying out cell-searching, and power consumption for carrying out cell-searching would increase.

In accordance with a certain related process, since it takes a short period of time (accordingly, power consumption is small) for measuring a strength of an electric field of received signals in comparison with carrying out cell-searching or receiving annunciation data (accordingly, power consumption is small), it is possible to shorten a period of time necessary for carrying out cell-searching and reduce power consumption by carrying out cell-searching in an order of a strength of an electric field of received signals after strengths of electric fields of received signals have been measured, or by carrying out cell-searching only for frequencies corresponding to strengths of electric fields of received signals higher than a predetermined strength.

However, since it is not possible in the above-mentioned process to identify a radio-signal communication system in measurement of strengths of electric fields of received signals, cell-searching may be carried out in synchronization with a cell at a frequency at which a different radio-signal communication system operates, resulting in that the cell-searching is in vain.

Hereinbelow is explained the above-mentioned problem with reference to FIGS. 2 to 5, using GSM and W-CDMA as an example of a radio-signal communication system.

A frequency to be used in GSM is defined in 3GPP TS 45.001 (non-patent reference 2), and a frequency to be used in W-CDMA is defined in 3GPP TS 25.101 (non-patent reference 3).

FIG. 2 shows frequency bands for GSM and W-CDMA FDD (Frequency Division Duplex) both of which operate at a frequency in the range of 800 MHz and 1000 MHz both inclusive. FIG. 3 shows frequency bands for GSM and W-CDMA FDD both of which operate at a frequency in the range of 1700 MHz and 2200 MHz both inclusive.

As shown in FIGS. 2 and 3, frequency bands which GSM may select overlap frequency bands which W-CDMA FDD may select. It depends on a country that which radio-signal communication system is used in which frequency band.

For instance, in FIG. 3, when a frequency band in W-CDMA FDD Band I is selected, a frequency in the range of 1920 MHz and 1980 MHz is used as an UL (UpLink: a direction to a base station from a mobile station) frequency. A DL (DownLink: a direction to a mobile station from a base station) frequency expected to be used in GSM 1900 or W-CDMA FDD Band II is in the range of 1930 MHz and 1990 MHz. A frequency in the range of 1930 MHz and 1980 MHz overlaps each other.

Thus, since frequencies in the range of 1930 MHz and 1980 MHz are equal to or higher in strength of an electric filed of received signals than a predetermined strength, a mobile station carries out cell-searching, regardless that those frequencies are of frequencies for W-CDMA FDD Band I, assuming that there exists a DL frequency of GSM 1900 Band or a DL frequency of W-CDMA FDD Band II. As a result, this cell-searching wastes time and current in vain.

As shown in FIGS. 2 and 3, GSM 850 Band and W-CDMA FDD Band V are defined to have a common frequency band in both UL and DL (UL: 824-849 MHz, DL: 869-894 MHz). Similarly, E-GSM 900 Band and W-CDMA FDD Band VIII are defined to have a common frequency band in both UL and DL (UL: 880-915 MHz, DL: 925-960 MHz). Similarly, GSM 1800 Band and W-CDMA FDD Band III are defined to have a common frequency band in both UL and DL (UL: 1710-1785 MHz, DL: 1805-1880 MHz). Similarly, GSM 1900 Band and W-CDMA FDD Band II are defined to have a common frequency band in both UL and DL (UL: 1850-1910 MHz, DL: 1930-1990 MHz). Which radio-signal communication system is used depends on a country of an operator.

FIGS. 4 and 5 show examples of frequency arrangement defined when a radio-signal communication system depends on an operator, in a process of changing into W-CDMA as the third generation from GSM as the second generation.

Though there may be defined a guard band (a frequency band not used by any radio-signal communication system) in order to avoid interference among radio-signal communication systems when there are different radio-signal communication systems from one another, a guard band is not defined in the examples.

FIG. 4 shows an example of frequency arrangement defined when GSM and W-CDMA operate in each of frequency bands of GSM 850 Band and W-CDMA FDD Band V. FIG. 5 shows an example of frequency arrangement defined when GSM and W-CDMA operate in each of frequency bands of GSM 1900 Band and W-CDMA FDD Band II.

FIG. 5 further shows frequency bands of GSM 1800 Band and W-CDMA FDD Band III, and indicates that there is caused a problem in cell-searching in GSM 1800 Band and GSM 1900 Band when a frequency for W-CDMA FDD Band II is used.

### SUMMARY OF THE INVENTION

In view of the above-mentioned problems in the existing radio-signal communication system, it is an object of the present invention to provide a radio-signal communication system, a mobile terminal device to be used in the radio-signal communication system, a method of detecting a frequency used in the radio-signal communication system and the mobile terminal device, and a program for carrying out the method all of which are capable of effectively detecting an actually used frequency.

In a first exemplary aspect of the present invention, the present invention provides a mobile communication system including a mobile terminal device having a function of making communication through one of radio-signal communication systems and at one of frequency bands, and a base station making communication with the mobile terminal device, wherein the mobile terminal device includes a controller therein, and the controller administrates, as frequency data, both actually-used frequency data indicative of a frequency actually used for each of frequency bands of each of the radio-signal communication systems, and non-used frequency data indicative of a frequency not actually used, determines a non-used frequency in accordance with the actually-used frequency data, determines non-used frequency data for each of frequency bands of each of the radio-signal communication systems in accordance with the thus determined non-used frequency, and stops cell-searching to be carried out to a frequency of a radio-signal communication system administrated with the non-used frequency data.

It is preferable that the controller carries out the cell-searching only to a frequency of a radio-signal communication system which may be actually used except frequencies of radio-signal communication systems administrated with the non-used frequency data.

It is preferable that the controller carries out the cell-searching including cell-searching only for frequencies having been used in the past, and cell-searching for a radio-signal communication system and a frequency band both having been used in the past.

It is preferable that the controller memorizes, as the actually-used frequency data, a frequency having been actually detected in the cell-searching.

It is preferable that the controller memorizes, as the actually-used frequency data, data of a frequency included in adjacent-cell data included in annunciation data and measurement control data both transmitted from the base station.

It is preferable that the controller updates the actually-used frequency data only with frequencies which are confirmed to be used, at an arbitrary time.

It is preferable that the controller memorizes a frequency which is confirmed to be used, as past actually-used frequency data, at an arbitrary time.

It is preferable that the controller memorizes present actually-used frequency data and past actually-used frequency data independently of each other in accordance with a frequency which is confirmed to be used at an arbitrary time and a frequency which is confirmed to have been used in the past.

It is preferable that the controller deletes the past actually-used frequency data when a period of time during which the mobile terminal device is out of a service area has passed over a predetermined period of time, when the mobile terminal device enters another country, or when movement of the mobile terminal device is detected by means of a GPS (Global Positioning System) function of the mobile terminal device.

It is preferable that the controller administrates the actually-used frequency data for each country, or administrates the actually-used frequency data independently of one another together with data indicative of a location of the mobile terminal device, provided by means of a GPS (Global Positioning System) function of the mobile terminal device.

The mobile terminal device may be comprised of a mobile phone device, for instance.

In a second exemplary aspect of the present invention, the present invention further provides a mobile terminal device having a function of making communication through one of radio-signal communication systems and at one of frequency bands, and making communication with a base station by virtue of the function, wherein the mobile terminal device includes a controller therein, and the controller administrates, as frequency data, both actually-used frequency data indicative of a frequency actually used for each of frequency bands of each of the radio-signal communication systems, and non-used frequency data indicative of a frequency not actually used, determines a non-used frequency in accordance with the actually-used frequency data, determines non-used frequency data for each of frequency bands of each of the radio-signal communication systems in accordance with the thus determined non-used frequency, and stops cell-searching to be carried out to a frequency of a radio-signal communication system administrated with the non-used frequency data.

In the mobile terminal device in accordance with the present invention, it is preferable that the controller carries out the cell-searching only to a frequency of a radio-signal communication system which may be actually used except frequencies of radio-signal communication systems administrated with the non-used frequency data.

In the mobile terminal device in accordance with the present invention, it is preferable that the controller carries out the cell-searching including cell-searching only for frequencies having been used in the past, and cell-searching for a radio-signal communication system and a frequency band both having been used in the past.

In the mobile terminal device in accordance with the present invention, it is preferable that the controller memorizes, as the actually-used frequency data, a frequency having been actually detected in the cell-searching.

In the mobile terminal device in accordance with the present invention, it is preferable that the controller memorizes, as the actually-used frequency data, data of a frequency included in adjacent-cell data included in annunciation data and measurement control data both transmitted from the base station.

In the mobile terminal device in accordance with the present invention, it is preferable that the controller updates the actually-used frequency data only with frequencies which are confirmed to be used, at an arbitrary time.

In the mobile terminal device in accordance with the present invention, it is preferable that the controller memorizes a frequency which is confirmed to be used, as past actually-used frequency data, at an arbitrary time.

In the mobile terminal device in accordance with the present invention, it is preferable that the controller memorizes present actually-used frequency data and past actually-used frequency data independently of each other in accordance with a frequency which is confirmed to be used at an arbitrary time and a frequency which is confirmed to have been used in the past.

In the mobile terminal device in accordance with the present invention, it is preferable that the controller deletes the past actually-used frequency data when a period of time during which the mobile terminal device is out of a service area has passed over a predetermined period of time, when the mobile terminal device enters another country, or when movement of the mobile terminal device is detected by means of a GPS (Global Positioning System) function of the mobile terminal device.

In the mobile terminal device in accordance with the present invention, it is preferable that the controller administrates the actually-used frequency data for each country, or administrates the actually-used frequency data independently of one another together with data indicative of a location of the mobile terminal device, provided by means of a GPS (Global Positioning System) function of the mobile terminal device.

The mobile terminal device in accordance with the present invention may be comprised of a mobile phone device, for instance.

In a third exemplary aspect of the present invention, the present invention further provides a method of detecting a frequency used in communication made between a base station and a mobile terminal device having a function of making communication through one of radio-signal communication systems and at one of frequency bands, including a first step of administrating, as frequency data, both actually-used frequency data indicative of a frequency actually used for each of frequency bands of each of the radio-signal communication systems, and non-used frequency data indicative of a frequency not actually used, a second step of determining a non-used frequency in accordance with the actually-used frequency data, a third step of determining non-used frequency data for each of frequency bands of each of the radio-signal communication systems in accordance with the thus determined non-used frequency, and a fourth step of stopping cell-searching to be carried out to a frequency of a radio-signal communication system administrated with the non-used frequency data, the first to fourth steps being carried out by the mobile terminal device.

In the method in accordance with the present invention, it is preferable that the mobile terminal device carries out the cell-searching only to a frequency of a radio-signal communication system which may be actually used except frequencies of radio-signal communication systems administrated with the non-used frequency data.

In the method in accordance with the present invention, it is preferable that the mobile terminal device carries out the cell-searching including cell-searching only for frequencies having been used in the past, and cell-searching for a radio-signal communication system and a frequency band both having been used in the past.

In the method in accordance with the present invention, it is preferable that the mobile terminal device memorizes, as the actually-used frequency data, a frequency having been actually detected in the cell-searching.

In the method in accordance with the present invention, it is preferable that the mobile terminal device memorizes, as the actually-used frequency data, data of a frequency included in adjacent-cell data included in annunciation data and measurement control data both transmitted from the base station.

In the method in accordance with the present invention, it is preferable that the mobile terminal device updates the actually-used frequency data only with frequencies which are confirmed to be used, at an arbitrary time.

In the method in accordance with the present invention, it is preferable that the mobile terminal device memorizes a frequency which is confirmed to be used, as past actually-used frequency data, at an arbitrary time.

In the method in accordance with the present invention, it is preferable that the mobile terminal device memorizes present actually-used frequency data and past actually-used frequency data independently of each other in accordance with a frequency which is confirmed to be used at an arbitrary time and a frequency which is confirmed to have been used in the past.

In the method in accordance with the present invention, it is preferable that the mobile terminal device deletes the past actually-used frequency data when a period of time during which the mobile terminal device is out of a service area has passed over a predetermined period of time, when the mobile terminal device enters another country, or when movement of the mobile terminal device is detected by means of a GPS (Global Positioning System) function of the mobile terminal device.

In the method in accordance with the present invention, it is preferable that the mobile terminal device administrates the actually-used frequency data for each country, or administrates the actually-used frequency data independently of one another together with data indicative of a location of the mobile terminal device, provided by means of a GPS (Global Positioning System) function of the mobile terminal device.

In a fourth exemplary aspect of the present invention, the present invention further provides a computer-readable storage medium storing therein a program for causing a computer to carry out a method of detecting a frequency used in communication made between a base station and a mobile terminal device having a function of making communication through one of radio-signal communication systems and at one of frequency bands, the computer being mounted in the mobile terminal device, steps executed by the computer in accordance with the program including a first step of administrating, as frequency data, both actually-used frequency data indicative of a frequency actually used for each of frequency bands of each of the radio-signal communication systems, and non-used frequency data indicative of a frequency not actually used, a second step of determining a non-used frequency in accordance with the actually-used frequency data, a third step of determining non-used frequency data for each of frequency bands of each of the radio-signal communication systems in accordance with the thus determined non-used frequency, and a fourth step of stopping cell-searching to be carried out to a frequency of a radio-signal communication system administrated with the non-used frequency data.

In accordance with the present invention, if two or more radio-signal communication systems different from one another may use a common frequency band, when a mobile terminal device which conforms to a plurality of radio-signal communication systems and a plurality of frequency bands detects a frequency, the mobile terminal device determines a frequency not used in each of frequency bands, based on actually used radio-signal communication systems and frequencies, to thereby identify a frequency for which cell-searching is to be carried out. Thus, it is possible to effectively detect an actually used frequency.

In accordance with the present invention, if two or more radio-signal communication systems different from one another may use a common frequency band, when a mobile terminal device which conforms to a plurality of radio-signal communication systems and a plurality of frequency bands detects a frequency, the mobile terminal device memorizes a radio-signal communication system which operates at a particular frequency, and the frequency, and determines a frequency not used in each of frequency bands, based on the memorized radio-signal communication system and frequency. The present invention makes it possible to effectively detect an actually used frequency by carrying out cell-searching only at frequencies except non-used frequencies.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram illustrating a structure of a mobile communication system in accordance with an exemplary embodiment of the present invention.

FIG. 2 shows a frequency band for GSM and a frequency band for W-CDMA FDD both in the range of 800 MHz and 1000 MHz both inclusive.

FIG. 3 shows a frequency band for GSM and a frequency band for W-CDMA FDD both in the range of 1700 MHz and 2200 MHz both inclusive.

FIG. 4 shows an example of frequency arrangement defined when GSM and W-CDMA operate in each of frequency bands of GSM 850 Band and W-CDMA FDD Band V.

FIG. 5 shows an example of frequency arrangement defined when GSM and W-CDMA operate in each of frequency bands of GSM 1900 Band and W-CDMA FDD Band II.

FIG. 6 is a flow-chart showing steps which a mobile phone device repeatedly carries out when a power of the mobile phone device is on, when the mobile phone device is located out of a service area, or when the mobile phone device is in a stand-by mode.

FIG. 7 is a flow-chart showing steps to be carried out in the step (step S4 in FIG. 6) for carrying out cell-searching at a candidate frequency.

FIG. 8 illustrates a method of determining a non-used frequency (step S16 in FIG. 7).

FIG. 9 illustrates a method of determining a non-used frequency (step S16 in FIG. 7).

FIG. 10 illustrates a method of determining a non-used frequency (step S16 in FIG. 7).

FIG. 11 illustrates a method of determining a non-used frequency (step S16 in FIG. 7).

FIG. 12 is a flow-chart showing steps to be carried out in a method of determining a non-used frequency (step S16 in FIG. 7).

### DESCRIPTION OF THE EXEMPLARY EMBODIMENTS

An exemplary embodiment in accordance with the present invention will be explained hereinbelow with reference to drawings.

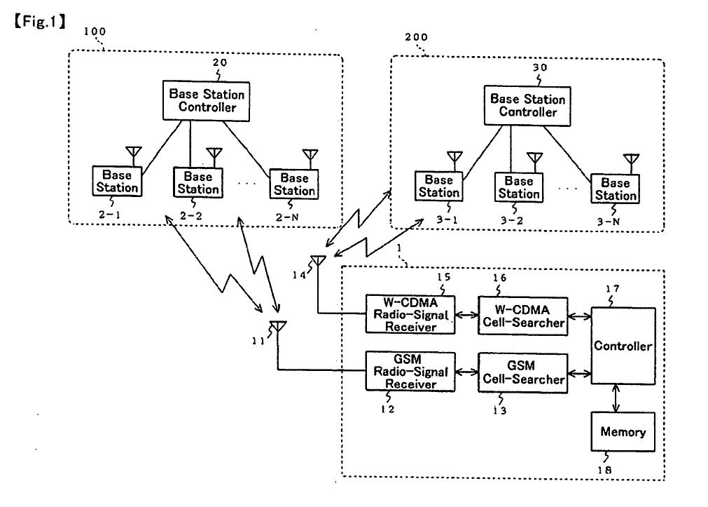

FIG. 1 is a block diagram illustrating a structure of a mobile communication system in accordance with an embodiment of the present invention.

As illustrated in FIG. 1, the mobile communication system in accordance with the embodiment is comprised of a mobile phone device 1, a GSM network 100 making communication with the mobile phone device 1, and a W-CDMA network 200 making communication with the mobile phone device 1.

The mobile phone device 1 is comprised of a GSM (Global System for Mobile Communications) antenna 11, a GSM radio-signal receiver 12, a GSM cell-searcher 13, a W-CDMA (Wideband-Code Division Multiple Access) antenna 14, a W-CDMA radio-signal receiver 15, a W-CDMA cell-searcher 16, a controller 17, and a memory 18.

The GSM network 100 is comprised of N GSM-type base stations 2-1, 2-2, • • • , 2-N, and a GSM-type base station controller 20 controlling operation of the base stations 2-1, 2-2, • • • , 2-N.

The W-CDMA network 200 is comprised of N W-CDMA-type base stations 3-1, 3-2, • • • , 3-N, and a W-CDMA-type base station controller 30 controlling operation of the base stations 3-1, 3-2, • • • , 3-N.

The GSM antenna 11 equipped in the mobile phone device 1 receives radio-signals from the base stations 2-1 to 2-N controlled by the base station controller 20 in the GSM network 100.

The GSM radio-signal receiver 12 demodulates radio-signals received by the GSM antenna 11.

The GSM cell-searcher 13 controls the demodulation carried out by the GSM radio-signal receiver 12 in accordance with a request transmitted from the controller 17, measures a strength of an electric field of received signals, and carries out cell-searching in synchronization with a GSM cell, to thereby receive annunciation data transmitted from the GSM-type base stations 2-1 to 2-N.

The W-CDMA antenna 14 equipped in the mobile phone device 1 receives radio-signals from the base stations 3-1 to 3-N controlled by the base station controller 30 in the W-CDMA network 200.

The W-CDMA radio-signal receiver 15 demodulates radio-signals received by the W-CDMA antenna 14.

The W-CDMA cell-searcher 16 controls the demodulation carried out by the W-CDMA radio-signal receiver 15 in accordance with a request transmitted from the controller 17, measures a strength of an electric field of received signals, and carries out cell-searching in synchronization with a W-CDMA cell, to thereby receive annunciation data transmitted from the W-CDMA-type base stations 3-1 to 3-N.

The controller 17 updates GSM actually used frequency data stored in the memory 18, in accordance with a DL (DownLink: a direction to a mobile station from a base station) frequency of a GSM cell having been detected in the GSM cell-searcher 13, and further updates W-CDMA actually used frequency data stored in the memory 18, in accordance with a DL frequency of a W-CDMA cell having been detected in the W-CDMA cell-searcher 16.

The controller 17 further determines a non-used frequency not used in each of frequency bands in accordance with those actually used frequency data, and updates both GSM non-used frequency data and W-CDMA non-used frequency data both stored in the memory 18, in accordance with the thus determined non-used frequency.

The controller 17 further requests the GSM cell-searcher 13 or the W-CDMA cell-searcher 16 to carry out cell-searching only at frequencies except non-used frequencies, which may be presently used.

The memory 18 stores frequency data for each of GSM frequency bands and each of W-CDMA frequency bands.

The frequency data is comprised of actually used frequency data and non-used frequency data.

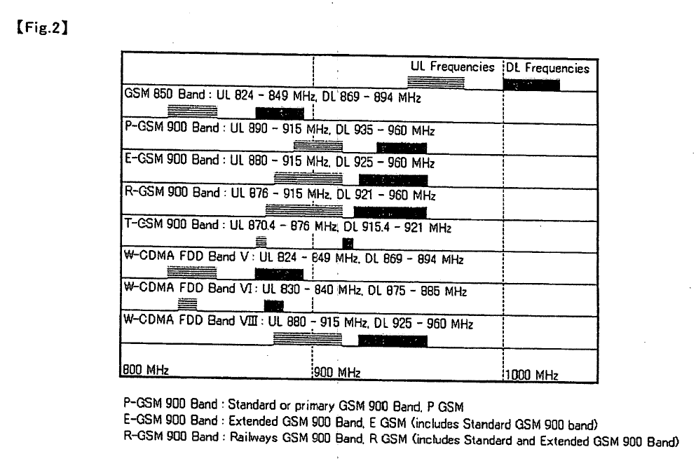

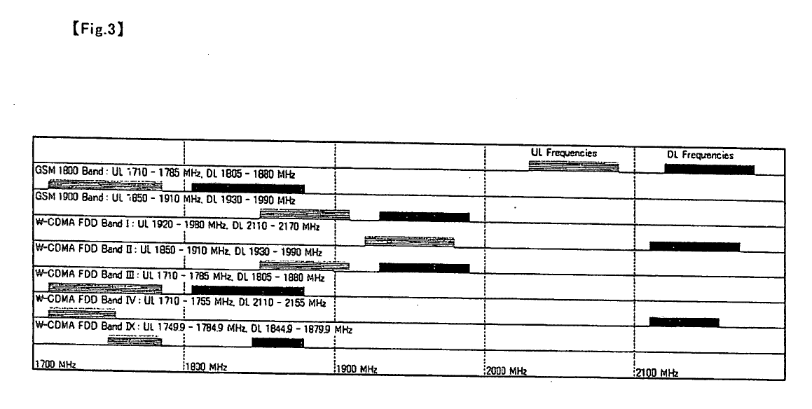

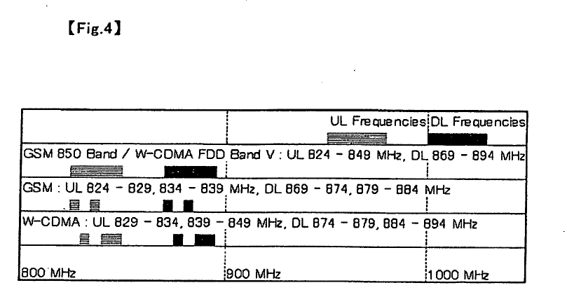

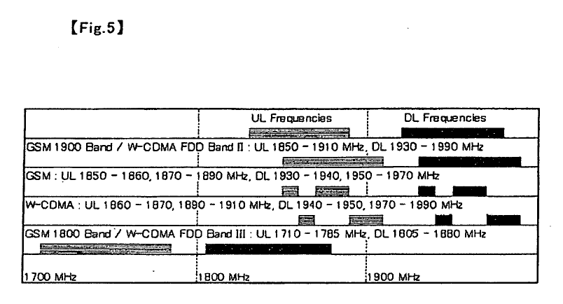

Each of actually used frequency data and non-used frequency data expresses all of central frequencies to be determined every 200 KHz in frequency bands used in GSM and W-CDMA FDD (Frequency Division Duplex) as shown in FIGS. 2 to 5. For instance, each of actually used frequency data and non-used frequency data can be expressed as a bit row convertible to each of central frequencies.

The memory 18 may store UL (UpLink: a direction from a mobile station to a base station) frequencies and DL frequencies as frequency data. As an alternative, the memory 18 may store a UL frequency and a DL frequency in a set, since a difference between a central frequency of UL frequencies and a central frequency of DL frequencies is constant.

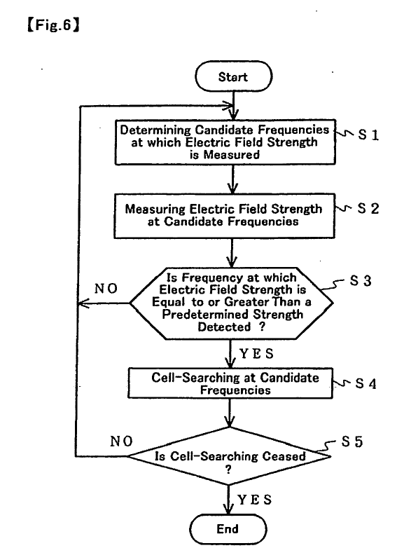

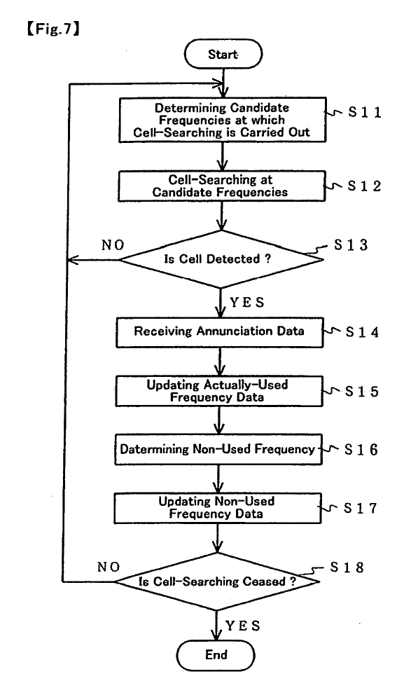

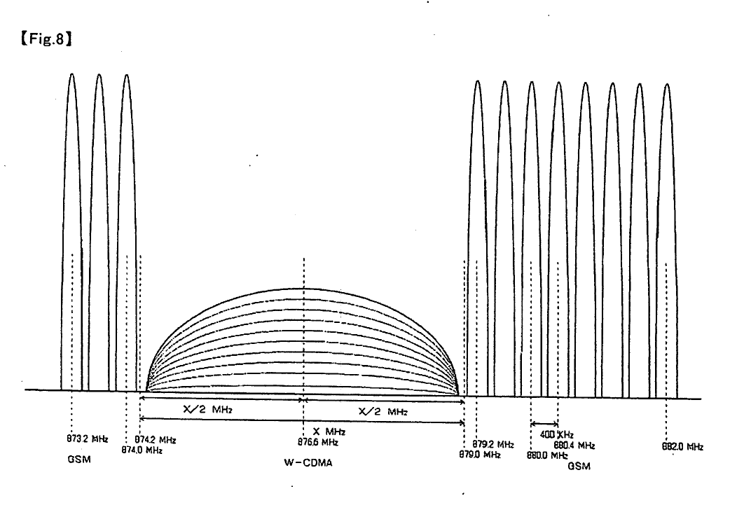

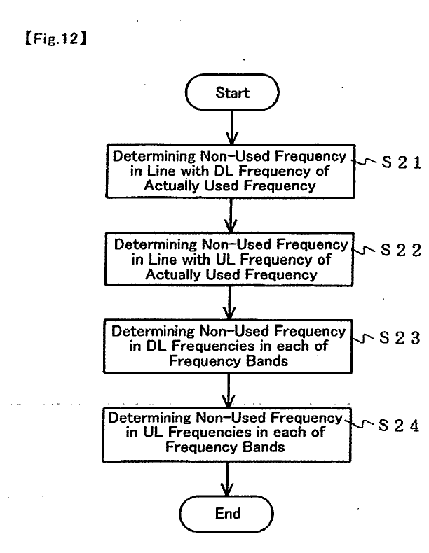

FIG. 6 is a flow-chart showing steps which the mobile phone device 1 repeatedly carries out when a power of the mobile phone device 1 is on, when the mobile phone device 1 is located out of a service area, or when the mobile phone device 1 is in a stand-by mode, FIG. 7 is a flow-chart showing steps to be carried out in the step (step S4 in FIG. 6) of carrying out cell-searching at a candidate frequency, FIGS. 8 to 11 illustrate a method of determining a non-used frequency (step S16 in FIG. 7), and FIG. 12 is a flow-chart showing steps to be carried out in a method of determining a non-used frequency (step S16 in FIG. 7).

Hereinbelow, a method of detecting a frequency in the mobile communication system in accordance with the embodiment of the present invention is explained with reference to FIGS. 1 to 12.

For instance, the controller 17 is comprised of a central processing unit (CPU), and operates in accordance with a program stored in the memory 18. In other words, the steps shown in FIGS. 6, 7 and 12 are carried out when the controller 17 carries out the program stored in the memory 18.

With reference to FIG. 6, there is explained steps repeatedly carried out by the mobile phone device 1 when a power of the mobile phone device 1 is on, when the mobile phone device 1 is located out of a service area, or when the mobile phone device 1 is in a stand-by mode.

The controller 17 determines a plurality of candidate frequencies at which a strength of an electric field of received signals is measured, in accordance with the frequency data stored in the memory 18 (step S1).

The controller 17 requests the GSM cell-searcher 13 or the W-CDMA cell-searcher 16 to measure a strength of an electric field of received signals only at the candidate frequencies having been determined at step S1. The GSM cell-searcher 13 or the W-CDMA cell-searcher 16 carries out measurement of a strength of an electric field of received signals at the candidate frequencies in compliance of a request received from the controller 17 (step S2).

The controller 17 judges whether a frequency associated with a strength of an electric field equal to or greater than a predetermined strength is detected in step S2 (step S3).

If a frequency associated with a strength of an electric field equal to or greater than a predetermined strength is not detected (NO in step S3), the controller 17 determines a plurality of candidate frequencies at which a strength of an electric field of received signals is measured (step S1).

If a frequency associated with a strength of an electric field equal to or greater than a predetermined strength is detected (YES in step S3), the controller 17 carries out cell-searching at the candidate frequencies, based on the results of measurements of a strength of an electric field in step S2, and the frequency data stored in the memory 18 (step S4).

Thereafter, the controller 17 judges whether cell-searching is to be ceased, in accordance with the results of carrying out the above-mentioned steps S1 to S4 (step S5).

The controller 17 ceases carrying out cell-searching when the candidate frequencies at which cells in GSM or W-CDMA may operate are all detected, or when a selected network is detected to thereby transfer into a stand-by mode in the case that the mobile phone device 1 is powered on and is located out of a service area (YES in step S5).

If cell-searching is not to be ceased (NO in step S5), the steps S1 to S4 are repeatedly carried out.

A method of determining a plurality of candidate frequencies at which a strength of an electric field for receiving signals is measured in step S1 in FIG. 6 may be comprised of (1) a step of limiting the candidate frequencies to a small number of frequencies having been used immediately before or in the past, in accordance with the actually-used frequency data stored in the memory 18, (2) a step of limiting the candidate frequencies to a radio-signal communication system or a frequency band having been used immediately before or in the past, in accordance with the actually-used frequency data stored in the memory 18, (3) a step of selecting all frequencies as candidates without limiting the candidate frequencies to certain frequencies, and (4) a step of limiting the candidate frequencies to frequencies which may be used, without non-used frequencies, in accordance with the non-used frequency data stored in the memory 18.

The above-mentioned steps (1), (2), and (3) were carried out in the related art. The present invention is characterized in carrying out the step (4). However, it should be noted that not only the step (4), but also the steps (1), (2) and (3) are carried out in dependence on status of the mobile phone device 1.

Hereinafter, the step of carrying out cell-searching at the candidate frequencies (step S4 in FIG. 6) is explained with reference to FIG. 7.

The controller 17 determines candidate frequencies at which cell-searching is to be carried out, in an order in which a higher strength of an electric field for receiving signals is earlier selected, in accordance with the result of measurement (step S2 in FIG. 6) of a strength of an electric field for receiving signals, and the frequency data stored in the memory 18 (step S11)

The controller 17 requests the GSM cell-searcher 13 or the W-CDMA cell-searcher 16 to carry out cell-searching at the candidate frequencies having been determined in step S11.

The GSM cell-searcher 13 or the W-CDMA cell-searcher 16 carries out cell-searching at the candidate frequencies in compliance with the request received from the controller 17 (step S12).

The controller 17 judges whether a cell can be detected by the cell-searching having been carried out in step S12 (step S13).

If a cell cannot be detected (NO in step S13), the controller 17 again determines candidate frequencies at which cell-searching is to be carried out, in step S1.

If a cell can be detected (YES in step S13), the controller 17 carries out a step of receiving annunciation data (step S14).

The controller 17 calculates a UL frequency of a GSM cell in accordance with a DL frequency of a GSM cell having been detected by the GSM cell-searcher 13 in step S12, and updates the GSM actually-used frequency data stored in the memory 18, in accordance with the DL and UL frequencies of the GSM cell (step S15).

Furthermore, the controller 17 calculates a UL frequency of a W-CDMA cell in accordance with a DL frequency of a W-CDMA cell having been detected by the W-CDMA cell-searcher 16 in step S12, and updates the W-CDMA actually-used frequency data stored in the memory 18, in accordance with the DL and UL frequencies of the W-CDMA cell (step S15).

Then, the controller 17 determines GSM non-used frequencies and W-CDMA non-used frequencies in accordance with the actually used frequencies (step S16), and updates the GSM non-used frequency data and the W-CDMA non-used frequency data both stored in the memory 18 (step S17).

Then, the controller 17 judges whether the step of carrying out cell-searching is to be ceased, in accordance with the results of carrying out the above-mentioned steps S11 to S17 (step S18).

The controller 17 ceases carrying out cell-searching when the candidate frequencies at which a strength of an electric field for receiving signals higher than a predetermined strength was detected are all detected in the step of measuring a strength of an electric field for receiving signals (step S12 in FIG. 6), or when a selected network is detected to thereby transfer into a stand-by mode in the case that the mobile phone device 1 is powered on and is located out of a service area (YES in step S18).

If cell-searching is not to be ceased (NO in step S18), the steps S11 to S17 are repeatedly carried out.

Hereinbelow, a method of determining a non-used frequency (step S16 in FIG. 7) is explained with reference to FIGS. 8 to 11.

When radio-signal communication systems different from one another are used, though there may be defined a guard band (a frequency band not used by any radio-signal communication system) in order to avoid interference among the radio-signal communication systems, a guard band is not defined in the examples shown in FIGS. 8 to 11.

FIG. 8 illustrates an example of frequency arrangement in the case that GSM and W-CDMA operate at frequencies adjacent to each other.

For simplification, FIG. 8 illustrates central frequencies among frequencies 873.2 MHz to 882.0 MHz corresponding to DL frequency bands of GSM 850 Band and W-CDMA FDD Band V. That is, FIG. 8 illustrates an example in which GSM operate at six frequencies in the range of 873.2 MHz and 874.0 MHz and fifteen frequencies in the range of 879.2 MHz and 882.0 MHz, and W-CDMA operates at a frequency of 876.6 MHz.

In FIG. 8, an interval between central frequencies in W-CDMA is expressed as X MHz. Since a diffusion band in W-CDMA is generally 5 MHz, FIG. 8 illustrates that an interval between the central frequencies in W-CDMA is 4.8 MHz (specifically, 874.2 MHz to 879.0 MHz).

Since an interval between carrier waves in GSM is 400 KHz (200 KHz interleave), an interval between central frequencies in GSM is set equal to 400 KHz.

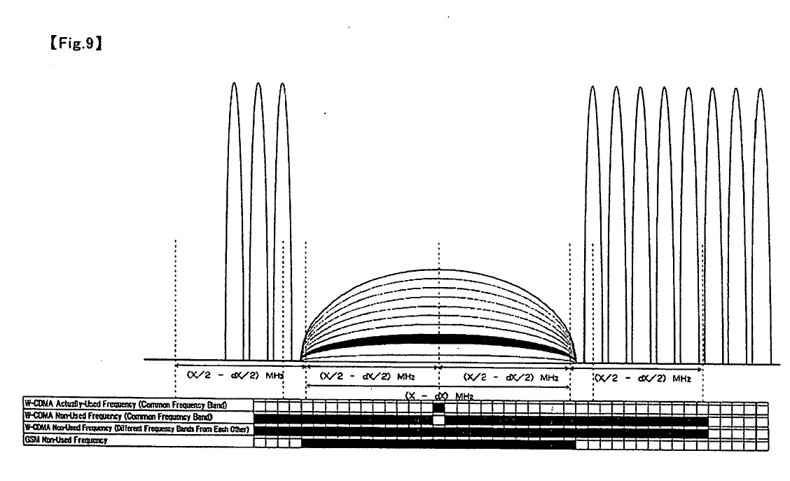

FIG. 9 illustrates a relation between the actually-used frequency data and the non-used frequency data in the case that a W-CDMA cell is detected.

Hereinbelow, a method of determining a non-used frequency (step S16 in FIG. 7) in the case that a W-CDMA cell is detected is explained with reference to FIG. 9.

Since it is considered that common frequencies are not used in radio-signal communication systems in order to avoid interference among those radio-signal communication systems, it is expected that when a W-CDMA cell is detected, other frequencies do not exist around a detected frequency within a range of X/2 MHz.

In the current embodiment, a non-used frequency is defined as a central frequency included in a non-used frequency band in which a certain frequency is considered not to exist. In order to ensure that the certain frequency does not exist, “dX” (for instance, about 400 KHz) is introduced to thereby define a non-used frequency band as (X-dX) MHz.

When a W-CDMA cell is detected, with respect to a frequency band identical with W-CDMA actually-used frequency, non-used frequencies are defined as frequency bands of (X-dX) MHz around the W-CDMA actually-used frequency, except the W-CDMA actually-used frequency.

With respect to a frequency band different from a W-CDMA actually-used frequency, non-used frequencies are defined as frequency bands of (X-dX) MHz around the W-CDMA actually-used frequency.

Frequency bands of (X/2-dX/2) MHz existing around a W-CDMA actually-used frequency are defined as a GSM non-used frequency.

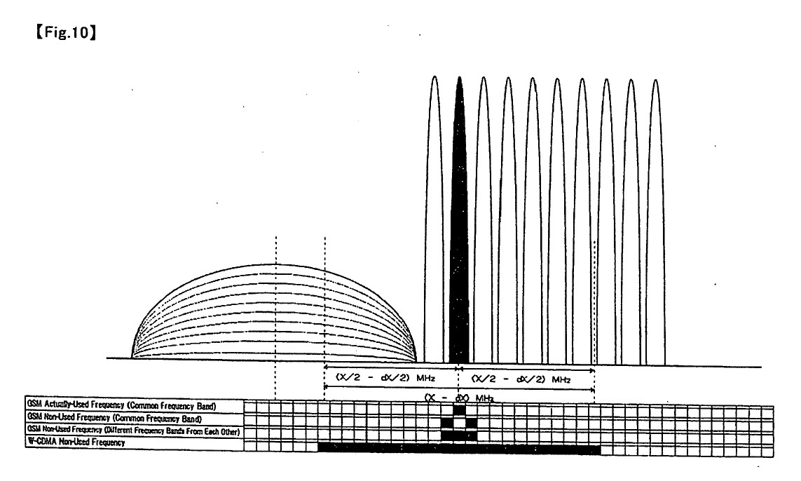

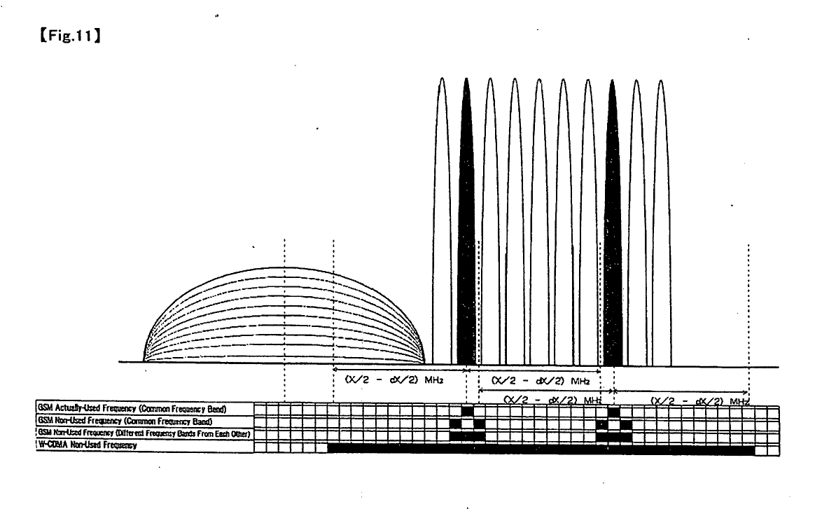

FIGS. 10 and 11 illustrate a relation between actually-used frequency data and non-used frequency data in the case that a GSM cell is detected.

Hereinbelow, a method of determining non-used frequency (step S16 in FIG. 7) in the case that a GSM cell is detected is explained with reference to FIG. 10.

When a GSM cell is detected, since GSM cells are considered to exist in a 400 KHz band therearound, with respect to a frequency band identical with a GSM actually-used frequency, non-used frequencies are defined as frequency bands of 200 KHz around the GSM actually-used frequency.

With respect to a frequency band different from a GSM actually-used frequency, non-used frequencies are defined as the GSM actually-used frequency and frequency bands of 200 KHz around the GSM actually-used frequency.

It is not considered that a central frequency in W-CDMA exists in X/2 MHz bands around a GSM actually-used frequency. Accordingly, using dX similarly to the above-mentioned manner, a W-CDMA non-used frequency is defined as frequency bands of (X/2-dX/2) MHz around a GSM actually-used frequency.

FIG. 11 illustrates an example in which when a GSM cell is detected, (X/2-dX/2) MHz bands around the GSM actually-used frequency are also defined as a W-CDMA non-used frequency.

The step of determining a non-used frequency (step S16 in FIG. 7) is explained hereinbelow with reference to FIG. 12.

The controller 17 determines a non-used frequency in accordance with a DL frequency of an actually used frequency, in accordance with the above-mentioned process (step S21).

Furthermore, the controller 17 determines a non-used frequency in accordance with a UL frequency of an actually used frequency (step S22).

If the non-used frequencies having been determined in steps S21 and S22 are included in a DL frequency of each of frequency bands, the controller 17 defines the DL frequency together with an UL frequency associated with the DL frequency as a non-used frequency in each of frequency bands (step S23).

If the non-used frequencies having been determined in steps S21 and S22 are included in a UL frequency of each of frequency bands, the controller 17 defines the UL frequency together with a DL frequency associated with the UL frequency as a non-used frequency in each of frequency bands (step S24).

As mentioned above, in accordance with the present embodiment, there are determined frequencies not used in a frequency band associated with each of radio-signal communication systems, in accordance with both the radio-signal communication systems using particular frequencies, and the frequencies, and cell-searching for the non-used frequencies is not carried out. Thus, it is possible to omit wastefully carrying out cell-searching, and hence, reduce power consumption. In particular, if radio-signal communication systems different from one another operate in a common frequency band, it would be possible almost not to wastefully carry out cell-searching.

In the present embodiment, in accordance with both radio-signal communication systems using particular frequencies, and the frequencies, frequencies not used in a frequency band associated with each of the radio-signal communication systems are determined, and cell-searching is carried out only for a frequency which may be used in a radio-signal communication system, except the non-used frequencies. Thus, it is possible to shorten a period of time necessary for carrying out cell-searching, and effectively detect a frequency which is actually used. In particular, the present embodiment is effective in the case that radio-signal communication systems different from one another operate in a common frequency band.

Furthermore, in the present embodiment, as well as cell-searching is carried out for a frequency which may be used, except non-used frequencies, cell-searching for a small number of frequencies which were used immediately before or in the past, and cell-searching for a radio-signal communication system and a frequency band both having been used immediately before or in the past are carried out together. Thus, it is possible to shorten a period of time necessary for carrying out cell-searching, and reduce power consumption, making it possible to effectively detect an actually used frequency.

In the above-mentioned embodiment, a frequency actually detected in cell-searching is stored as an actually-used frequency. It should be noted that even if the mobile phone device 1 does not detect an actually-used frequency, since frequency data included in adjacent-cell data included in annunciation data and measurement control data both transmitted from a base station is considered as an actually used frequency, the frequency may be stored as an actually-used frequency. By storing the frequency as an actually-used frequency, actually-used frequency data increases, and accordingly, non-used frequency data to be determined in accordance with actually-used frequency increases, it would be possible to more effectively detect an actually used frequency.

Though the above-mentioned embodiment of the present invention does not refer to a frequency which cannot be detected, it is necessary to delete a frequency which cannot be detected from actually-used frequency data, and determine again non-used frequency data in accordance with actually used frequencies.

The actually-used frequency data may be administrated as follows for instance. (1) The actually-used frequency data may be updated on occasion only with frequencies which were confirmed to be actually used at a certain time. (2) The actually-used frequency data is not updated on occasion, but may be stored without being deleted as data about frequencies having been used in the past. (3) Data of presently actually used frequencies and data of frequencies having been actually used in the past are stored independently of each other in accordance with frequencies which are confirmed to be used at a certain time and frequencies which are confirmed to have been used in the past.

In the above-mentioned (3), data of frequencies having been actually used in the past (A) may be deleted as time during which the mobile phone device is located out of a service area goes by, (B) may be deleted when the mobile phone device moves into a strange country, or (C) may be deleted when the movement of the mobile phone device is detected by means of GPS (Global Positioning System). By carrying out these steps, it is possible to effectively detect actually used frequencies.

By administrating the actually-used frequency data for each of countries or individually administrating the actually-used frequency data together with location data in synchronization with GPS, even if the mobile phone device moves over countries for global roaming, it is possible to effectively detect actually used frequencies in accordance with how frequencies are used in each of countries.

The exemplary advantages obtained by the above-mentioned exemplary embodiments are described hereinbelow.

In accordance with the above-mentioned exemplary embodiment, it is possible to effectively detect an actually used frequency, when a mobile terminal device having a function of making communication thorough a plurality of radio-signal communication systems and at a plurality of frequency bands makes communication with a base station.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

1. A mobile communication system including:
a mobile terminal device having a function of making communication through one of radio-signal communication systems and at one of frequency bands; and
a base station making communication with said mobile terminal device,
wherein said mobile terminal device includes a controller therein, and
said controller administrates, as frequency data, both actually-used frequency data indicative of a frequency actually used for each of frequency bands of each of said radio-signal communication systems, and non-used frequency data indicative of a frequency not actually used, determines a non-used frequency in accordance with said actually-used frequency data, determines non-used frequency data for each of frequency bands of each of said radio-signal communication systems in accordance with the thus determined non-used frequency, and stops cell-searching to be carried out to a frequency of a radio-signal communication system administrated with said non-used frequency data.

2. The mobile communication system as set forth in claim 1, wherein said controller carries out said cell-searching only to a frequency of a radio-signal communication system which may be actually used except frequencies of radio-signal communication systems administrated with said non-used frequency data.

3. The mobile communication system as set forth in claim 1, wherein said controller carries out said cell-searching including cell-searching only for frequencies having been used in the past, and cell-searching for a radio-signal communication system and a frequency band both having been used in the past.

4. The mobile communication system as set forth in claim 1, wherein said controller memorizes, as said actually-used frequency data, a frequency having been actually detected in said cell-searching.

5. The mobile communication system as set forth in claim 1, wherein said controller memorizes, as said actually-used frequency data, data of a frequency included in adjacent-cell data included in annunciation data and measurement control data both transmitted from said base station.

6. The mobile communication system as set forth in claim 1, wherein said controller updates said actually-used frequency data only with frequencies which are confirmed to be used, at an arbitrary time.

7. The mobile communication system as set forth in claim 1, wherein said controller memorizes a frequency which is confirmed to be used, as past actually-used frequency data, at an arbitrary time.

8. The mobile communication system as set forth in claim 1, wherein said controller memorizes present actually-used frequency data and past actually-used frequency data independently of each other in accordance with a frequency which is confirmed to be used at an arbitrary time and a frequency which is confirmed to have been used in the past.

9. The mobile communication system as set forth in claim 7, wherein said controller deletes said past actually-used frequency data when a period of time during which said mobile terminal device is out of a service area has passed over a predetermined period of time, when said mobile terminal device enters another country, or when movement of said mobile terminal device is detected by means of a GPS (Global Positioning System) function of said mobile terminal device.

10. The mobile communication system as set forth in claim 1, wherein said controller administrates said actually-used frequency data for each country, or administrates said actually-used frequency data independently of one another together with data indicative of a location of said mobile terminal device, provided by means of a GPS (Global Positioning System) function of said mobile terminal device.

11. The mobile communication system as set forth in claim 1, wherein said mobile terminal device is comprised of a mobile phone device.

12. A mobile terminal device having a function of making communication through one of radio-signal communication systems and at one of frequency bands, and making communication with a base station by virtue of said function,
wherein said mobile terminal device includes a controller therein, and
said controller administrates, as frequency data, both actually-used frequency data indicative of a frequency actually used for each of frequency bands of each of said radio-signal communication systems, and non-used frequency data indicative of a frequency not actually used, determines a non-used frequency in accordance with said actually-used frequency data, determines non-used frequency data for each of frequency bands of each of said radio-signal communication systems in accordance with the thus determined non-used frequency, and stops cell-searching to be carried out to a frequency of a radio-signal communication system administrated with said non-used frequency data.

13. The mobile terminal device as set forth in claim 12, wherein said controller carries out said cell-searching only to a frequency of a radio-signal communication system which may be actually used except frequencies of radio-signal communication systems administrated with said non-used frequency data.

14. The mobile terminal device as set forth in claim 12, wherein said controller carries out said cell-searching including cell-searching only for frequencies having been used in the past, and cell-searching for a radio-signal communication system and a frequency band both having been used in the past.

15. The mobile terminal device as set forth in claim 12, wherein said controller memorizes, as said actually-used frequency data, a frequency having been actually detected in said cell-searching.

16. The mobile terminal device as set forth in claim 12, wherein said controller memorizes, as said actually-used frequency data, data of a frequency included in adjacent-cell data included in annunciation data and measurement control data both transmitted from said base station.

17. The mobile terminal device as set forth in claim 12, wherein said controller updates said actually-used frequency data only with frequencies which are confirmed to be used, at an arbitrary time.

18. The mobile terminal device as set forth in claim 12, wherein said controller memorizes a frequency which is confirmed to be used, as past actually-used frequency data, at an arbitrary time.

19. The mobile terminal device as set forth in claim 12, wherein said controller memorizes present actually-used frequency data and past actually-used frequency data independently of each other in accordance with a frequency which is confirmed to be used at an arbitrary time and a frequency which is confirmed to have been used in the past.

20. The mobile terminal device as set forth in claim 18, wherein said controller deletes said past actually-used frequency data when a period of time during which said mobile terminal device is out of a service area has passed over a predetermined period of time, when said mobile terminal device enters another country, or when movement of said mobile terminal device is detected by means of a GPS (Global Positioning System) function of said mobile terminal device.

21. The mobile terminal device as set forth in claim 12, wherein said controller administrates said actually-used frequency data for each country, or administrates said actually-used frequency data independently of one another together with data indicative of a location of said mobile terminal device, provided by means of a GPS (Global Positioning System) function of said mobile terminal device.

22. The mobile terminal device as set forth in claim 12, wherein said mobile terminal device is comprised of a mobile phone device.

23. A method of detecting a frequency used in communication made between a base station and a mobile terminal device having a function of making communication through one of radio-signal communication systems and at one of frequency bands, comprising:
a first step of administrating, as frequency data, both actually-used frequency data indicative of a frequency actually used for each of frequency bands of each of said radio-signal communication systems, and non-used frequency data indicative of a frequency not actually used;
a second step of determining a non-used frequency in accordance with said actually-used frequency data;
a third step of determining non-used frequency data for each of frequency bands of each of said radio-signal communication systems in accordance with the thus determined non-used frequency; and
a fourth step of stopping cell-searching to be carried out to a frequency of a radio-signal communication system administrated with said non-used frequency data,
said first to fourth steps being carried out by said mobile terminal device.

24. The method as set forth in claim 23, wherein said mobile terminal device carries out said cell-searching only to a frequency of a radio-signal communication system which may be actually used except frequencies of radio-signal communication systems administrated with said non-used frequency data.

25. The method as set forth in claim 23, wherein said mobile terminal device carries out said cell-searching including cell-searching only for frequencies having been used in the past, and cell-searching for a radio-signal communication system and a frequency band both having been used in the past.

26. The method as set forth in claim 23, wherein said mobile terminal device memorizes, as said actually-used frequency data, a frequency having been actually detected in said cell-searching.

27. The method as set forth in claim 23, wherein said mobile terminal device memorizes, as said actually-used frequency data, data of a frequency included in adjacent-cell data included in annunciation data and measurement control data both transmitted from said base station.

28. The method as set forth in claim 23, wherein said mobile terminal device updates said actually-used frequency data only with frequencies which are confirmed to be used, at an arbitrary time.

29. The method as set forth in claim 23, wherein said mobile terminal device memorizes a frequency which is confirmed to be used, as past actually-used frequency data, at an arbitrary time.

30. The method as set forth in claim 23, wherein said mobile terminal device memorizes present actually-used frequency data and past actually-used frequency data independently of each other in accordance with a frequency which is confirmed to be used at an arbitrary time and a frequency which is confirmed to have been used in the past.

31. The method as set forth in claim 29, wherein said mobile terminal device deletes said past actually-used frequency data when a period of time during which said mobile terminal device is out of a service area has passed over a predetermined period of time, when said mobile terminal device enters another country, or when movement of said mobile terminal device is detected by means of a GPS (Global Positioning System) function of said mobile terminal device.

32. The method as set forth in claim 23, wherein said mobile terminal device administrates said actually-used frequency data for each country, or administrates said actually-used frequency data independently of one another together with data indicative of a location of said mobile terminal device, provided by means of a GPS (Global Positioning System) function of said mobile terminal device.

33. A computer-readable storage medium storing therein a program for causing a computer to carry out a method of detecting a frequency used in communication made between a base station and a mobile terminal device having a function of making communication through one of radio-signal communication systems and at one of frequency bands, said computer being mounted in said mobile terminal device, steps executed by said computer in accordance with said program including:
a first step of administrating, as frequency data, both actually-used frequency data indicative of a frequency actually used for each of frequency bands of each of said radio-signal communication systems, and non-used frequency data indicative of a frequency not actually used;
a second step of determining a non-used frequency in accordance with said actually-used frequency data;
a third step of determining non-used frequency data for each of frequency bands of each of said radio-signal communication systems in accordance with the thus determined non-used frequency; and
a fourth step of stopping cell-searching to be carried out to a frequency of a radio-signal communication system administrated with said non-used frequency data.
